(19) United States
(12) Patent Application Publication
(10) Pub. No.: US 2005/0071232 A1
(43) Pub. Date: Mar. 31, 2005

(54) Credit system for restaurant tables and bars

(75) Inventor: Stephanie A. Frater, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Stephanie A. Frater, Chicago, IL (US)

(21) Appl. No.: 10/968,681

(22) Filed: Oct. 19, 2004

(51) Int. Cl. G06F 17/60

(52) U.S. Cl. 705/16

(57) ABSTRACT

A restaurant table or other customer location is configured with a customer register that is provided with a financial card reader and a screen with display and data input options. The customer register is utilized to establish communications and make payments at a main register. A receipt printer may also be provided. The display and data input screen device has the option to automatically compute server tip as a percentage of the total balance due and confirm the balance charged to the respective credit card. The financial card reader and the display and data input screen are utilized to establish communication between the restaurant or bar main register and the customer register in order to make credit card payments from the customer register to the restaurant or bar main register. The receipt printer is utilized to print receipts having a value equal to the dollar amount charged to the credit card from the customer register after the balance is confirmed through a touch screen method. The customer swipes their credit card before ordering food and multiple credit cards can be swiped so that more than one person can utilize the customer register at the table. Alternatively, or additionally, the customer(s) swipe the credit card(s) after ordering; however, the customer register connects to a light switch device, prominently displayed at the top of the customer register that changes to a specific color to designate that the balance owed at the table has been paid.

### FIELD OF THE INVENTION

This invention relates generally to facilitating payments at restaurant tables and bars, and more particularly to a method and apparatus for establishing payments, including gratuity, at the site of restaurant tables or bars.

### BACKGROUND

People throughout the world enjoy dining and joining friends and family for drinks at restaurants, bars, and similar venues. Often customers will wait at a restaurant table or bar for an extended period of time waiting for a server to accept, process, and return their credit card(s). This process can take forty-five minutes or longer to complete depending on the ratio of customers to servers in the particular specific food services venue. Sometimes, after an extended period of time, an overworked server may even forget to process a credit card for a customer all together and will have to be reminded of their mistake by the impatient customer. Any impatience may be eventually reflected in the gratuity allocated to the server. In addition to affecting the amount of gratuity, payment delays can strongly impact customer satisfaction. Secondly, calculating the appropriate standard tip for service is often a tedious process, particularly for customers who are not adept to making such calculations in their heads.

At the present time, however, if a restaurant, bar, or other food services establishment is overcrowded, a customer may wait several minutes for the bill, thus decreasing the turnover of customers, and reducing profitability for the locale. Meanwhile, servers of the restaurant, bar or other food service venue are overworked and exhausted from unnecessary running around. The various disclosed embodiments have been designed in consideration of these and other problems.

### SUMMARY

In a preferred embodiment, a credit system is provided for restaurant tables and bars. In the embodiment, individual restaurant tables and bars are provided with credit authorization facilities. For instance, the tables and bars may be provided with a table-based apparatus that includes a financial card reader and associated display and data input screen devices. More generally, a customer register can be provided at any predetermined customer location.

In accordance with this embodiment, when a customer, sitting at a table, completes her order, she uses the credit system to ensure that any bill for food and services is properly paid. Accordingly, the bill is shown at the display for customer approval. The financial card reader can then be used as a data input device. According to a further embodiment, the customer may also input a percentage or total gratuity and input approval for charges.

Once a financial card, such as a debit or credit card, is accepted by the reader, the table-based apparatus transmits a signal to a main customer register. The customer register, in turn, authorizes the requested credit. A printer located at the restaurant table may be configured to generate a receipt confirming the balance paid by the customer.

According to a further embodiment, the server may scan the customer's credit card for approval before ordering. Thus, if a customer leaves without completing a sale, any balance owed can be charged, including gratuity and fees as applicable. An alternative embodiment includes a signaling apparatus, such as a light, that provides a signal to the customer, server, and/or security, indicating that the financial card has been approved. If a light is included, it may, for example, change to a designated color when credit is approved. In further embodiments, voice activation service, restaurant menu display, and other comparable adjustments are available.

Thus, in this manner a customer makes a credit card payment without waiting for a server to process the payment for them.

Various embodiments in the detailed description and claims provide more detail and alternative approaches. Thus, this brief summary should not be seen as a limitation of the invention.

### BRIEF DESCRIPTION OF THE DRAWINGS

The following Detailed Description and accompanying Drawings provide a more complete understanding of the embodiments:

FIG. 1 is a schematic drawing of an embodiment of a payment system for restaurant tables.

FIG. 2 is a block diagram of a customer register.

FIG. 3 is a screen shot of an embodiment in operation.

FIG. 4 is a screen shot of an embodiment in operation.

FIG. 5 is a screen shot of an embodiment in operation.

FIG. 6 is a screen shot of an embodiment in operation.

FIGS. 7-9 are illustrations of profile views of embodiments of a customer register at a venue table.

### DETAILED DESCRIPTION

### 1. Overview of Various Embodiments

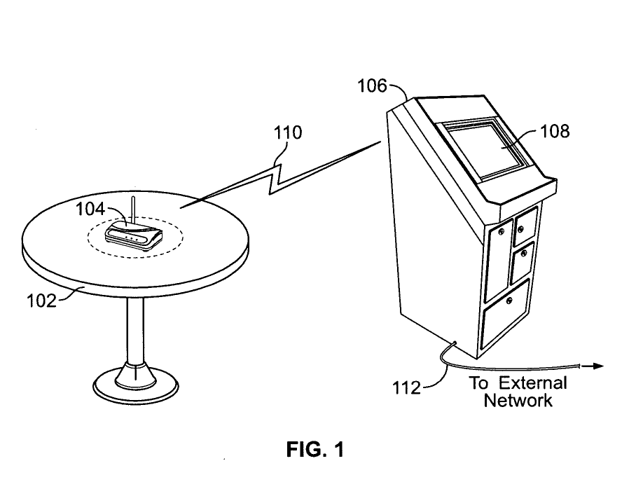

FIG. 1 is a schematic drawing showing an embodiment of a payment system for restaurant tables and is useful for providing an overview of some features. This embodiment is expected to be implemented in a restaurant although other locations are possible.

As shown, a customer register 104 is co-located with a restaurant table 102. The customer register 104 is communicatively coupled with a main register 106 through communication link 110 (such as a radio-frequency or wired link). According to this embodiment, the main register 106 has a user input/output 108 for entering or retrieving customer and order information. An external communications link 112 is shown linking the main register 106 with an external network such as the PSTN or Internet.

A primary function of the customer register 104 is to quickly process customer payment. As such, according to this embodiment, the customer register 104 includes a financial card reader that a patron can use to “swipe” his or her credit or debit card. Preferably, the financial card reader can be used to obtain information from a variety of financial-type cards such as credit cards, debit cards, ATM cards, pre-paid cards, personal information cards, point cards, or any other type of card, which may be used to establish communication with a financial card reader for the purpose of making a payment or providing information.

The customer register 104 also includes a user input/output (I/O). The user I/O may, for example, take the form of an interactive display, touch-screen or graphical user interface. Likewise, a keypad, mouse, pen, or other device may be available for data entry. The customer register may also include a receipt printer, a communications port for communicating with the main register 106, and a transaction signaling device for indicating whether the user has completed a transaction. Memory, processors, and other hardware and software may be integrated as needed.

During operation, the payment system is used to provide a customer with easy access to a combination of ordering, bill review, and payment functions. Although it is expected that the customer will still have interaction with a server, the customer will not be required to wait for the server to bring a bill or process payment. Likewise, the customer may be able to request help from a server using the system. Further, the system provides a transaction signal apparatus that can be used to ensure that a customer has properly completed payment. The signal apparatus may, for example, operate by lighting up with a specific color when a bill has not been paid, and then changing its color once the sale is finalized. Alternatively, the signal apparatus may also be a noise maker such as a horn. In yet another embodiment, the signal apparatus may provide a signal at a remote location or may transmit a signal over a radio-frequency link.

### 2. Exemplary Customer Register

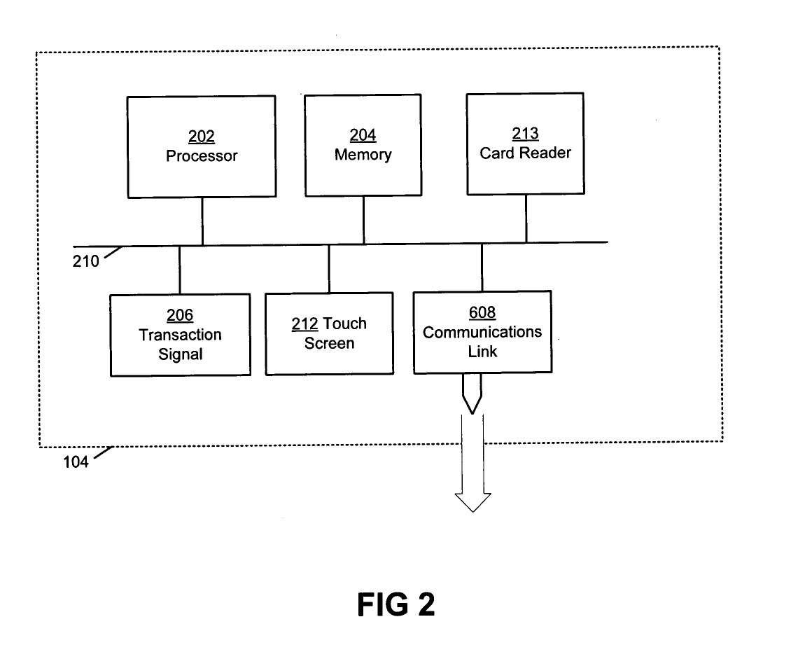

FIG. 2 provides a block diagram showing various elements of an exemplary customer register 104. The elements are shown communicatively coupled through a bus 210. A card reader 214 provides an input mechanism for a customer to provide payment information. For example, a customer may interact with the card reader 214 by swiping or inserting a credit card or other financial type card. Several types of card readers are available and are known to those skilled in the art. Another embodiment may include a radio frequency (RF) based card reader using RFID technology or the like. A touch screen 212 provides another input mechanism for the customer, as well as an output mechanism for the system. For example, the customer may review and accept a bill through the touch screen 212. Likewise, the touch screen may be configured for customer signature or other means of approval.

Memory 204 provides a location for the storage of both data and machine readable instructions or programs. Memory may take many forms including short term and long term memory, hard disk, flash, CDROM, and DMA, and MRAM, for example. A processor 202 is coupled with the bus 210 and is useful for executing the programs stored in memory.

The customer register 104 may be co-located with a restaurant table as shown in FIG. 1. The customer register 104 may be attached or built into the restaurant table. Other embodiment provide for the customer register 104 to be attached to a bar, booth, chair, wall, or any accessible point. Preferably, attachment of the customer register 104 should not cause a loss of function to its attachment point. For example, the restaurant table may be configured to continue to function as an eating and drinking area even after the customer register 104 is attached. In an alternative embodiment, the customer register 104 may be a hand-held device tethered to the restaurant table or other appropriate base. When wireless communication is available and there is a low potential or downside of theft, the customer register 104 may be embodied as a free-floating hand held unit.

### 3. Exemplary Operation

Operation of an embodiment is described below. The customer register 104 can be configured to approve credit cards before ordering. Thus, owners of a venue are ensured that only customers with approved credit cards receive service. Because of pre-approval, if the customer leaves the restaurant with out formally approving the balance or total amount owed, the venue also will be able to charge for the balance plus a reasonable gratuity, as determined by the restaurant or food services venue.

Thus, according to this embodiment, a customer must swipe their credit card into the financial card reader 214 to obtain a preliminary credit approval.

Next, the customer places their order with a server. The server, in turn, proceeds to the main register 106 to manually input the customer's order. One skilled in the art will recognize that the server's role thus far is standard to the food service industry. Information manually inputted at the main register 106 is automatically transferred to the customer register 104 and may be displayed on the screen 212. During this time, an order value (for example, food, beverages, and merchandise) is established and a balance shown in the screen 212. The screen 212 may be configured to show advertisements or non-related images or videos when it is not in use. Thus, the customer may need to touch the screen 212 to view the balance or other order-related information. The screen 212 may be configured to show a “screensaver” from advertisers during non-usage periods. Functionally, the screensaver is useful for distracting the customers so that they do not worry about keeping track of the price of their food and drink.

As the customer continues to order additional items, new orders are added to list of items and the balance recalculated. This may follow the pattern discussed above. Specifically, the server proceeds to the main register 106 at the restaurant to manually input the additional orders from the customer into the main register in order to establish an updated balance in the screen 212. This additional information inputted in the main register 106 by the server is automatically transferred to the screen 212. During this time, the value of the total food and beverage products purchased establishes a new balance in the screen 212 to reflect the additional items ordered. The customer may still have to touch the screen of the screen 212 to view the content of the screen 1.4 because the screen 212 will contain a screensaver from advertisers or the particular restaurant or food services venue.

In another embodiment, the customer register 104 is configured to allow the customer to interactively order food. Thus, the customer may select items from an electronic menu or key in item numbers or names. Further a search function may be enabled to reveal all dishes or products that fall within certain categories. Likewise, customers may have the option of searching by name, viewing pictures of the food, viewing an ingredient list, etc.

Once a customer decides that she is through ordering, she can immediately pay for the entire order (plus gratuity) using the customer register 104. The first step in paying for the balance is to press the screen 212 to remove the screensaver. Removal of the screensaver may trigger the screen to display some combination of the following information: customer name (cardholder name); a line item list of items ordered, including food, beverages, merchandise, and services; a line item list of the dollar amount owed for each of the respective food and beverage items ordered; a total line calculating the total amount owed by each respective customer; a gratuity reminder. The gratuity reminder may, for example, be a flashing line indicating for the cardholder to add a gratuity for the server. The gratuity may be added initially at and the customer given the option of increasing or decreasing the tip.

The screen 212 could also display any of the various other types of displays that are commonly utilized in association with drive-through-window payment screens, payments per online invoices on computers, and the like. Likewise, other forms of display and data input apparatus may replace or be added to the screen 212. For example, the customer register 104 may be include a keyboard or any of the various other input devices commonly utilized in conjunction with payment machines, computers, and the like. FIG. 6 provides a view of an example exit screen that may be shown after payment is complete.

### 4. Multiple Payers

A common problem at dining venues is how to “split the bill.” Generally, it is easiest to simply divide payment evenly by person or by cardholder. However, this method is often inequitable. Additionally, the method halving the bill encourages individuals to order larger items because they will only pay for a portion of their order. Although that method may bring more revenue in the short-term, customers may be left feeling short-changed. Thus, it is important to provide a good method of splitting the bill according to the size of each persons order.

According to embodiments of the present invention, multiple financial cards may be swiped or otherwise entered into the system. At any time, the customers while sitting around the table may assign each order item to a specific cardholder. In this way, the bill will be split according to the order. An additional benefit of this method is that it will allow an individual to leave early without worrying that she has paid too much or too little.

In operation, splitting the bill according to items ordered may be accomplished through a number of means. In one embodiment, a first customer selects his items from a displayed bill of sale. The first customer then indicates a payment method and any gratuity before finally approving payment of the selected portion of the bill. The items that have been paid for may be removed from the list, or may change color to indicate that they are paid. Other methods of indicating payment are also available.

After the first customer has paid, a second customer would repeat the steps of selecting items to pay for and then approving payment. This cycle may continue until all items are paid. For ease of use, at any point, a customer may pay for the entire remaining bill.

Because some customers will want to split a bill 50/50 or according to another percentage, functionality is provided in an embodiment for a percentage based bill split.

Further, the customer register may provide functionality for splitting a single line item. This may be accomplished by dividing the cost of the item by the number of customers to pay for the item. For example, if a group of ten people go out to dinner and split a bottle of wine, then two people share an entree, each person can pay for 10% of the cost of the wine and the people who shared the entree would each add an additional 50% of the cost of the entree to their respective payments.

### 5. Screen Shots

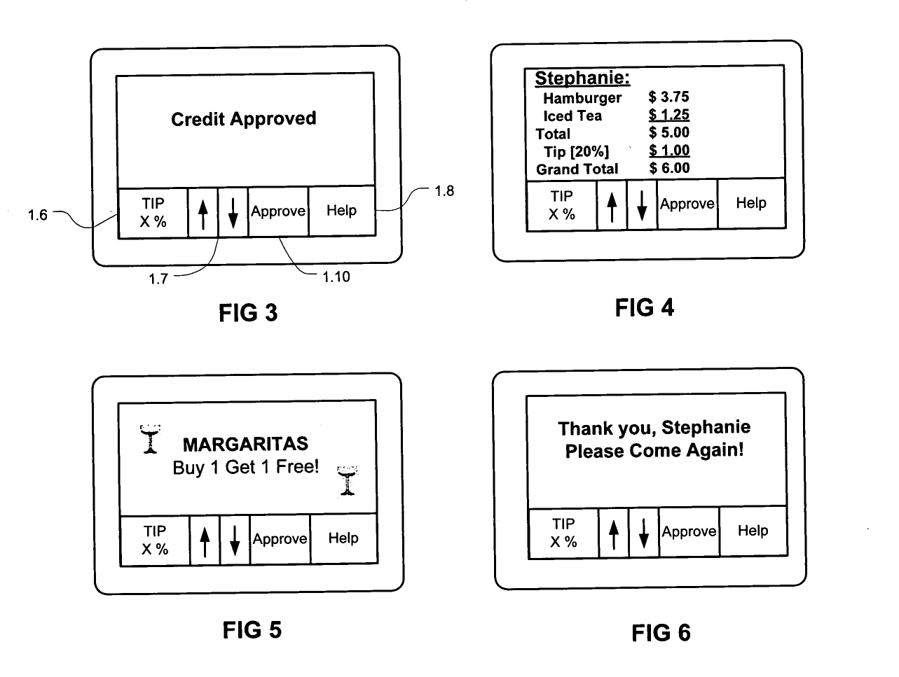

FIGS. 3-6 provide various screen shots to show the system in operation. In FIG. 3, the screen 300 may be touch screen 212 or another type of display. At the bottom of the screen 300, a tip button or area 1.6 is shown with a marked percentage sign and indications to represent the standard tip at the specific restaurant or food services industry. If the venue prefers a ten key pad or the like in order to manually input a percentage of gratuity, then the credit customer register 104 can be arranged so that the cardholder would use the screen 300 to manually input the percentage for gratuity or the dollar amount for gratuity. There are two arrow buttons 1.7 that indicate an increase or decrease in the percentage of tip. A customer who normally would struggle in computing the appropriate gratuity to add to the balance will now have the customer register 104 compute the tip for the server automatically and instantaneously. The up and down arrows and moves the percentage to a very small fraction, such as 0.01%, each time the cardholder pushes the button; however the restaurant or food services venue will decide how they would like this portion of the screen to work. Every time the customer pushes and up or down arrow 1.7, the processor 202 calculates the new grand total balance using a program stored in memory 204. This way the customer can view the impact of a certain percentage of tips on the grand total amount to be charged to the credit card, and calculate a reasonable server tip without a struggle. Once the cardholder decides upon a reasonable tip they will hit the approved button 1.10, whereupon the flashing line for gratuity will turn solid. A help button 1.8 is also provided. The help button may establish communication with a light-bulb device prominently displayed at the top of the customer register. The light may turn a designated color to indicate the cardholder needs assistance. Now the cardholder can view the above items listed for the content of the screen, plus the following: Grand Total Balance for the total amount owed for the ordered food and beverage, including gratuity.

If the customer has any problems with processing an order, or does not understand the content of the screen 1.4, or if the customer has any other inquires regarding payment using the credit customer register 104 they have the option of pressing the help button 1.8. If the cardholder presses the help button 1.8, the help button 1.8 communicates and activates the light bulb device 1.9 prominently displayed at the top of the credit customer register 104. The light bulb flashes a designated color to indicate to the server and wait staff that the cardholder has a question or problem regarding the credit customer register 104. Alternatively, pressing the help button 1.8 may alert the server or staff through other signaling means. Further, pressing the help button 1.8 may alternatively or additionally trigger an electronic help function that can tutor the customer on proper operation of the customer register 104.

If an error in processing occurs and the order screen is incorrect per the screen 300 the server can proceed to a main cash resister and clear the order or a portion of the order and reenter the correct agreed upon information. On some embodiment of the credit customer register, the server will may clear and reenter orders at the table using the customer register directly, by entering an identifier such as a user name and pass code to make such corrections. Alternatively, the server may be provided with an administrative card that may be swiped at the card reader as a means of authorization.

Once the credit cardholder hits the approve button 1.8 then the screen conveys the following type of message: Please swipe credit card.

If the credit card holder agrees with the total balance owed, plus gratuity, the next step is to swipe their credit card into the financial card reader 214. The financial card reader 214 processes the total amount owed, including gratuity, and automatically conveys this information to the main register 106 of the restaurant table, bar, or food services menu. Once the financial card reader 214 properly reads the credit card, assuming that the predetermined conditions for the issuance of credit to the owner of the financial card are fulfilled, the screen 1.4 displays the following information: Cardholder credit card processed; Thank you, please come again.

The screen 1.4 could also display any of the various other types of displays that are commonly utilized in association with drive through window payment screens, payments per online invoices on computers, and the like.

It is expected that many embodiments of the customer register 104 will include a screen display view after the customer approves the balance with the following example of view: Would you like a receipt? (Yes No).

The cardholder then has the option of deciding if they would like to print a receipt they will press the yes button and activate the printer. If the customer decides they do not want a receipt they will press the no button.

Once the balance is paid and completely processed, the light bulb device 1.9 is activated to turn a designated color so that the server, wait staff, and other restaurant or food services venue personnel can view that the cardholder has properly paid for their food before leaving the restaurant.

FIG. 4 displays a screen shot of an itemized bill. A receipt printer (not shown) is configured to print charge receipts showing both an amount charged on a bill and an itemized list of purchases. Preferably, an edge of the receipt printer is rigid so that a paper receipt may be torn off and removed cleanly be the credit card owner. The actual receipt would contain the following standard information listed on most receipts as shown below:
1. The name of the restaurant or food service venue.
2. The address the of restaurant or food service venue.
3. The content of the food and beverage products ordered.
4. The respective amounts owed for the above food and beverage products ordered.
5. The total balance for the food and products ordered.
6. The total gratuity
7. The grand total, including gratuity
8. A thank you note to the cardholder.

The above list is subject to change and variation as determined by the particular restaurant or food services venue. Further, the customer register may be configured to accept an e-mail address and e-mail the receipt.

According to this embodiment, the transaction signal device 206 is a colored light. Thus, once the balance is paid and completely processed, the transaction signal 206 is activated to turn a designated color so that the server, wait staff, and other restaurant or food services venue personnel can view that the cardholder has properly paid for their food before leaving the restaurant.

As displayed in FIG. 5, the restaurant or food service venue may decide to have one screensaver for the entire dining period, or multiple switching screensavers. According to an embodiment, the screensavers would have the same capacity of a screensaver used on a desktop computer or home PC. The screensavers are a way for restaurants or food service venues to advertise their own specials, restaurants, and deserts. Alternatively, the restaurant or food service venue could use the screensavers for advertisements from local or national companies. Thus, the advertisements provide a second profit method for the venue.

### 6. Table Integration

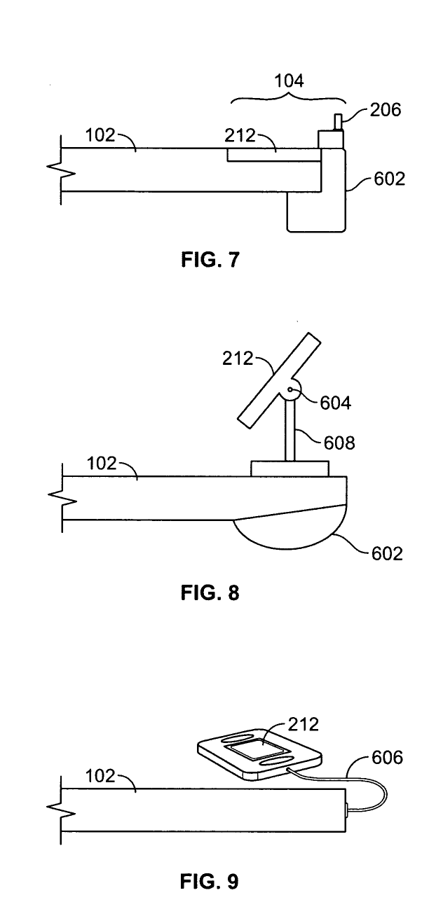

FIG. 7 demonstrates the capability of a customer register 104 to be built into a venue table 102. The built-in unit can provide for better use of the table surface, and better protection of the register and its parts. The venue could cover the table 102 with objects such as napkin holders, and condiments and the like so that the customer register 104 is not prominently visible by the customers. Further, table service may include cleaning screens or replacing a transparent screen protector to ensure cleanliness and safety.

The profile view of the customer register 104 is viewed in FIG. 7. The profile view displays how a receipt printer 602 is hidden under the table 102 (or on the side or above the table depending on the preference of the venue or the particular embodiment employed). The receipt printer 602 preferably contains a roll of paper to print the receipts for customers. A transaction signal device 206 may be embodied by a colored light or other signal device. The customer register 104 can be installed in the middle of the table as well.

It is contemplated that the component parts of the credit customer register 104 of the present invention are contained within a unitary housing. In the case of a new table, the housing may be more conveniently configured coincident with the structure the table. In the case of an existing restaurant or food services table, the housing could comprise a separate structure secured to and operatively connected to the table. In any case, it is contemplated that in many embodiments, a support structure will be included for mounting the customer register to the predetermined customer location.

FIG. 8 provides another profile view of a customer register station. A screen 212 is attached to a stand 608, which provides connectivity to the table 102. The printer 602 is shown under the edge of the table 102. Other locations of the printer 602 are available. A horizontal axis 604 is shown as a rotation point for the screen 212. This axis may allow for as much as 200 degrees of rotation in some embodiments. Alternatively, the rotation angle may be reduced in order to restrict movement of the screen. Although not shown, the screen may also be configured to swivel on the stand 608.

FIG. 9 provides yet another embodiment of the customer register 104. According to this embodiment, the screen 212 is encased in a hand-held unit that may be tethered to the table 102 or other location. The remaining elements of the customer register, as shown in FIG. 2, may also be incorporated into the hand-held unit. Alternatively, some elements, such as a printer, may be separately attached to the table or location. A tether 606 is shown securing the hand-held unit to the table 102. In addition to providing security, the tether may provide a power/data conduit. In yet another embodiment, the hand-held unit is not secured to the table through any means.

### 7. Steps of Exemplary Process

The following listing provides an exemplary operation of an embodiment of the system from the customer perspective.

STEP 1. The credit card of the cardholder is swiped through the financial card reader 214 of the customer register 104 and processed for approval.

STEP 2. The server enters the food and beverage order of the customer into the restaurant or food service venue main register 106.

STEP 3. The order is automatically processed and communicated back to the screen 212 as shown in FIG. 4. Steps 2 and 3 may repeat as many times as the customer continues to order additional food and beverage items.

STEP 4. The customer presses the screensaver to display the order on the screen 212.

STEP 5. The customer presses the server tip button 1.6 and a standard tip is automatically computed as a percentage of the total dollar balance owed for the cardholder.

STEP 6. The customer uses the arrow buttons 1.7 to increase or decrease the percentage of gratuity and the Grand Total Balance is shown to reflect the respective tip percentages.

STEP 7. When the customer agrees with the percentage of gratuity and Grand Total Balance, including gratuity, the customer presses the Approve button 1.8.

STEP 8. The customer uses the screen 1.4 to follow the instructions to swipe their credit card. The customer swipes their credit card through the financial card reader 214. This step is described in the text of FIG. 2 above.

STEP 9. The credit card grand total amount owed that the cardholder approved using the screen is communicated and processed to the main register 106.

STEP 10. As shown in FIG. 2, the main register 106 communicates to the credit customer register 104 that the order is complete.

STEP 11. The cardholder answers the question on the screen 1.4 of whether or not they would like a receipt printed to reflect the details of the order, including the grand total, plus gratuity.

STEP 12. If the customer decides that they would not like a receipt a message on the display and input screen indicates that their credit card has been successfully processed for the appropriate payment.

If the customer decides that they would like a receipt, the printer prints a receipt. The printer communicates to the screen that the receipt has been printed and a message on the display and input screen indicates that their credit card has been successfully processed for the appropriate payment.

STEP 13. The screen communicates to the light bulb device 1.9 to turn a designated color to indicate that that total dollar balance of the card holder has been successfully processed. This is shown in FIG. 4.

In another embodiment, a method is provided for splitting the bill at the customer register. According to this embodiment, each customer selects their items from the order summary displayed on the touch screen. After entering payment information, those selected items are removed from the order summary (or otherwise highlighted). Once all the items have been paid, the customer register will provide the transaction signal, thus indicating to venue staff that the order is complete.

### 8. Embodiments and Variations

The following models serve as a guide to describe the various features and variations available for the credit customer register 104. All models are subject to alteration and change depending on the preference of the restaurant or food services menu.

Model A is a low-end version of the credit customer register 104 including the following features: Financial Card Reader 214; Screen 212; Receipt Printer.

Model B is a moderate version of the credit customer register 104 constituting the above features mentioned in Model A, plus the following features: Light bulb to serve as the transaction signal 206; Menu keyboard working in conjunction with the Screen; Screensaver.

Model C is a high- end version of the credit customer register 104 constituting the above features mentioned in Model A, plus the following features: Voice activation system to work in conjunction with the Screen 212; Customer register 104 that is build into the restaurant or food services venue table; Entire menu of the restaurant or food service venue available to input by the customer of the screen 212; Personal calculator, ten key pad, or the like, available on the screen 212 so that the customer can directly input gratuity.

The above models serve as examples of various types of customer register options and are capable of numerous rearrangements, modifications, and substitutions of parts.

In further embodiments, the customer register is situated on a rotatable axis to make viewing and data entry easier for a human user. In particular, the axis may be a horizontal axis, thus allowing the touch screen to be tilted forward and back. Alternatively or additionally, the axis may be a vertical axis to allow the screen to rotate so that it is accessible to any person sitting around the table. For example, and without limitation, this embodiment may be configured to operate as a Lazy Susan around the table. Various embodiments of touch-screens are known to those in the art—in some cases, these screens may require an implement such as a “pen” for writing on the screen. In other embodiments, pointing a finger close to the screen may be sufficient for providing input at the screen.

In yet another embodiment, the customer register is incorporated with a video game located at a bar in a venue. According to an embodiment, the customer may win food credits or free food while playing the video game.

Although several embodiments of the invention have been both illustrated and described, it will be understood that the invention is not limited to the embodiments disclosed, but is capable of numerous rearrangements, modifications, and substitutions of parts and elements without departing from the spirit of the invention. For examples, elements described as circuit elements may be reproduced as other types of hardware, software, or firm-ware elements.

1. A user based payment system comprising:
a customer register located in a predetermined customer location, wherein the customer register includes a financial card reader for obtaining payment information from a customer, a customer I/O, and a transaction signal device for announcing whether a customer transaction has been completed, wherein the customer register is configured to provide a customer with access to order information; and
a main register configured to communicatively couple with the customer register, wherein the main register is configured to provide a seller with access to order information, and wherein the main register is configured to communicatively couple with a packet network for obtaining payment approval.

2. The payment system of claim 1, wherein the customer I/O includes a touch screen, and wherein the system is configured to provide an interactive display through the touch screen.

3. The payment system of claim 1, wherein the predetermined customer location is selected from the locations including a table and a bar.

4. The payment system of claim 1, wherein the customer register further includes a processor and memory, and wherein the memory includes a set of stored instructions, executable by the processor, for providing a customer the ability to determine one of a gratuity or service charge.

5. The payment system of claim 4, wherein the customer I/O includes a touch screen, and the system is configured to provide an interactive gratuity entry form at the touch screen for determining a gratuity.

6. The payment system of claim 1, further comprising a printer coupled to the customer register for providing a paper receipt.

7. The payment system of claim 6, wherein the customer location is a table, and wherein the printer is configured to attach to an underside of a top surface of the table.

8. The payment system of claim 1, wherein the customer register further includes a rotational axis for providing user access to the screen from various locations within the predetermined customer location.

9. The payment system of claim 8, wherein the rotational axis is a vertical rotational axis, wherein the customer I/O is configured to rotate about the rotational axis.

10. At a customer register situated in a predetermined customer location within a venue, a method for payment comprising:
upon receiving customer data at a financial card reader of the customer register, communicating at least a subset of the customer data to a main register for obtaining approval;
displaying an order summary at a screen of the customer register for customer approval;
displaying a gratuity calculation form at the screen of the customer register;
updating the order summary to reflect a customer entry in the gratuity calculation form;
upon customer approval, providing an indication of order completion to venue staff.

12. The method of claim 10, wherein the predetermined customer location is a restaurant dining table.

13. The method of claim 10, further comprising:
providing an interactive menu at the display of the customer register, wherein a customer may order items from the menu through the customer register.

14. The method of claim 10, wherein displaying an order summary comprises receiving a indication of the order summary from the main register;
storing the indication of the order summary in memory on the customer register; and
executing a first set of instructions stored on the customer register for displaying the order summary at the screen.

15. The method of claim 10, wherein providing an indication of order completion to venue staff comprises switching a lamp of the customer register to a designated color.

16. The method of claim 10, further comprising printing a customer receipt a printer of the customer register.

17. The method of claim 10, further comprising providing an e-mail copy of a customer receipt.

18. A method of splitting a bill comprising:
at a customer register situated in a predetermined customer location within a venue, receiving an indication of an order summary from a main register;
storing the order summary in memory at the customer register;
displaying the order summary at a display of the customer register;
for each paying customer, receiving a set of inputs from a customer I/O, wherein each set of inputs is indicative of payables for the respective customer;
iteratively modifying the order summary to indicate items that have been selected for payment by each respective customer;
receiving payment information at the customer register from each respective customer; and
providing an indication of the payment information to the main register for approval.

19. The method of splitting a bill of claim 18, wherein each set of inputs includes a list of items to be associated with payment information of the respective customers.

20. The method of splitting a bill of claim 19, wherein each order item may be associated with payment information from one or more customers, and wherein payment for an order item having multiple payees is divided amongst the payees.

21. The method of claim 18, wherein the customer register is configured to receive a first set of inputs and a first set of payment information and is configured to complete a first sale prior receiving further inputs, wherein a first customer may pay for a designated portion the order and leave the venue early.
